(19) United States
(12) Patent Application Publication
(10) Pub. No.: US 2025/0199296 A1
(43) Pub. Date: Jun. 19, 2025

(54) Lens Oil and Mist Prevention Device and Stage Luminaire Including Same

(71) Applicant: FLY DRAGON LIGHTING EQUIPMENT CO., LTD, Guangzhou (CN)

(72) Inventors: Xiangnong Zhang, Guangzhou (CN); Wei Zhang, Guangzhou (CN); Zhipeng Li, Guangzhou (CN); Xianbin Mo, Guangzhou (CN); Shipeng Liang, Guangzhou (CN)

(21) Appl. No.: 18/915,398

(22) Filed: Oct. 15, 2024

Related U.S. Application Data
(63) Continuation-in-part of application No. PCT/CN2024/082625, filed on Mar. 20, 2024.

(30) Foreign Application Priority Data
Dec. 15, 2023 (CN) 202311740029.9

(51) Int. Cl. G02B 27/00; F21V 29/15

(52) U.S. Cl. CPC G02B 27/0006; F21V 29/15

(57) ABSTRACT

The present invention discloses a lens oil and mist prevention device, including an optical lens and a layered thermal insulation assembly, wherein the layered thermal insulation assembly includes a layered thermal insulation disk and thermal insulation glass; and the thermal insulation glass is fixed in the layered thermal insulation disk in a layered interval arrangement in a light emerging direction, and the optical lens is disposed in a direction of a front end of the thermal insulation glass. In the present invention, natural generation and accumulation of oil stain and water mist in a lamp are eliminated from the source by means of a way that heat balance is achieved inside and outside the lens and the temperature difference is reduced, while designing a multi-layer thermal insulation zone as needed to gradually lower the temperature, and the oil and mist prevention effect is significantly better.

### CROSS REFERENCE TO RELATED APPLICATIONS

The present application is a Continuation-In-Part application of PCT Application No. PCT/CN2024/082625 filed on Mar. 20, 2024, which claims the benefit of Chinese Patent Application No. 202311740029.9 filed on Dec. 15, 2023. All the above are hereby incorporated by reference in their entirety.

### TECHNICAL FIELD

The present invention relates to the field of stage lighting, in particular to a lens oil and mist prevention device, and a stage luminaire including the lens oil and mist prevention device.

### BACKGROUND

With the rapid development of modern cultural tourism, stage luminaires are used more and more widely, and are no longer only applied to indoor performances, but also widely applied to outdoor live performances, theme parks, urban lighting projects, landscape lighting, outdoor cultural activity venues, and the like. When the stage luminaires are applied to the outdoors or places with a relatively humid environment, waterproof performance requirements are put forward on the stage luminaires. Therefore, a waterproof stage luminaire with a full-sealed structure is commonly used outdoors.

When the waterproof stage luminaire is used outdoors, there may be a temperature difference between the inside and outside of a lamp cap, or a temperature difference between the inside and outside of the lamp may be caused when a lamp body is powered off in a high heat state; and with the increase of the service life, lubricating greases for various mechanical structures inside the lamp naturally vaporize. since the interior of the lamp is in a full-sealed state, oil vapor and water vapor will condense inside the lamp, and it is easy to condense water droplets or mist-like oil vapor and water vapor on optical glass inside an optical lens of the lamp body (i.e., a light outlet), or form a mist-like halo, which seriously affects the light emerging effect of the lamp.

At present, in order to solve this problem, it is mainly solved by means of airflow circulation. One way is to make the lamp have a full-sealed structure, and avoid the accumulation of oil stain and mist by circulating and filtering gas inside the lamp. This way is effective in a short period of time, but the oil stain and water vapor always circulate inside the lamp, which will still affect the light emerging effect of the lens after a long period of time. Another way is to form an air inlet and an air outlet in the lamp, and drive an air flow in the lamp to exchange with outside air by a blowing mechanism to realize the internal and external circulation of the air, thereby regularly discharging the oil vapor and water vapor.

Although both ways can better solve the problem of accumulation of the oil stain and water mist, they essentially prevent the oil stain and water mist from adhering to the lens by driving the air flow in the lamp, the problem of generation of the oil stain and water mist is not solved from the source, which means that the lamp needs to be cleaned regularly, which is time-consuming and labor-intensive, but cannot avoid the continuous generation of new oil stain and water mist. Moreover, in the case of adopting the airflow circulation, it is necessary to equip the lamp with a corresponding air blowing device, air guiding device, airflow circuit, etc., and air circulation inside the lamp must be fully considered in structure, which means that the cost of lamp accessories will increase, and the structure inside the lamp is relatively complicated, and the lamp is heavy, making it difficult to achieve a compact structure.

### SUMMARY

In order to overcome the shortcomings in the prior art, a first object of the present invention is to provide a lens oil and mist prevention device, and a second object of the present invention is to provide a stage luminaire including the lens oil and mist prevention device, which can solve the problem of easy condensation of oil stain and water mist on an optical lens at a front end of a stage luminaire.

The present invention is achieved by the following technical solutions:
a lens oil and mist prevention device includes: an optical lens; and a layered thermal insulation assembly disposed under the optical lens, including: a layered thermal insulation disk and one or more pieces of thermal insulation glass, wherein the thermal insulation glass is fixed in the layered thermal insulation disk in a layered interval arrangement in a light emerging direction such that a plurality of stages of thermally insulating temperature division zones are formed in the layered thermal insulation disk; and the thermally insulating temperature division zones are chambers independent from each other, or different thermally insulating temperature division zones are chambers communicating with each other; and the optical lens is fixedly connected to the layered thermal insulation disk, or the optical lens is sealed and fixed in the layered thermal insulation disk; and the optical lens is disposed in a direction of a front end of the thermal insulation glass such that a lamp beam reaches the optical lens after sequentially passing through the plurality of stages of the thermally insulating temperature division zones.

Further, the layered thermal insulation disk has a hollow cylindrical structure; when the number of the thermal insulation glass is at least two, the layered thermal insulation assembly further includes: a glass spacer gasket; and the glass spacer gasket is fixed in the layered thermal insulation disk, and a top and a bottom of the glass spacer gasket respectively abut against the thermal insulation glass to form the thermally insulating temperature division zones between different thermal insulation glass.

Further, the layered thermal insulation disk has a trumpet-like structure with a wide upper part and a narrow lower part; an inner side wall of the layered thermal insulation disk is provided with a plurality of layers of mounting steps for placing the thermal insulation glass; and when the number of the thermal insulation glass is at least two, the thermal insulation glass is separately disposed on different mounting steps to form the thermally insulating temperature division zones between different thermal insulation glass.

Further, when the optical lens is fixedly connected to the layered thermal insulation disk, the lens oil and mist prevention device further includes: a lens mounting member and thermal insulation assembly supporting rods; and the optical lens is fixed in the lens mounting member, one ends of a plurality of the thermal insulation assembly supporting rods are connected to the lens mounting member, and the other ends of the plurality of the thermal insulation assembly supporting rods are fixed to the layered thermal insulation disk.

Further, when the optical lens is sealed and fixed in the layered thermal insulation disk, a top of the layered thermal insulation disk is provided with a circle of mounting steps for placing the optical lens; and the optical lens is fixedly disposed on the mounting steps so that a bottom of the optical lens is embedded inside the layered thermal insulation disk.

Further, the thermal insulation glass is any one of temperature-resistant and high-permeability coated optical glass, oil mist-resistant coated glass, temperature-resistant heat insulation glass, and ordinary glass.

Further, surfaces of the layered thermal insulation disk and the glass spacer gasket are provided with black matting patterns or an anti-reflection treatment layer.

Further, an interval gap inside the layered thermal insulation assembly is any one of an inert gas filling layer, a vacuum layer, and a natural air filling layer.

Further, the lens oil and mist prevention device further includes: a lens cover, wherein the optical lens and the layered thermal insulation assembly are both fixed in the lens cover.

A stage luminaire includes the lens oil and mist prevention device.

Further, the stage luminaire is not limited to a stage luminaire whose light source is a lamp bulb, an LED, a laser, and the like.

Compared with the prior art, the present invention can achieve the following beneficial effects:
the layered thermal insulation assembly is disposed at a front end, close to the optical lens, of an optical path, by arranging one, two or more pieces of thermal insulation glass in the layered thermal insulation disk as needed, one, two or more stages of the thermally insulating temperature division zones are formed, when a light beam of a light source passes through the thermally insulating temperature division zones in sequence, the effect of gradual cooling is achieved, so that inner and outer sides of each piece of the layered thermal insulation glass or the optical lens are close to heat balance, i.e., a temperature difference between the inner and outer sides is reduced, and the condensation of oil mist and water vapor is effectively avoided, and a good oil and mist prevention effect is achieved in practical use.

Compared with the prior art in which the accumulated oil stain and water mist are discharged by means of internal or external circulation of the air flow inside the lamp, in the present invention, the natural generation and accumulation of oil stain and water mist in the lamp are basically eliminated from the source by means of a way that heat balance is achieved inside and outside the lens and the temperature difference is reduced, while designing a multi-layer thermal insulation zone as needed to gradually lower the temperature, and the oil and mist prevention effect is significantly better. Moreover, it is not necessary to discharge gas in the lamp frequently and regularly, saving maintenance costs of a stage luminaire; and it is also not necessary to dispose various air blowing devices, air guiding devices, airflow circuits and the like inside the lamp, saving the cost of lamp accessories, and the internal structure of the stage luminaire can be more compact, lightweight and miniaturized, which is more in line with the current development trend of the stage luminaire.

### BRIEF DESCRIPTION OF THE DRAWINGS

FIG. 1 is a schematic diagram showing an internal structure of a stage luminaire;

FIG. 2 is a schematic exploded view of a lens cover, an optical lens, and a layered thermal insulation assembly;

FIG. 3 is a front view in Embodiment 1;

FIG. 4 is a schematic exploded view in Embodiment 1;

FIG. 5 is a cross-sectional view in Embodiment 1;

FIG. 6 is a perspective view in Embodiment 2;

FIG. 7 is a schematic exploded view in Embodiment 2;

FIG. 8 is a cross-sectional view in Embodiment 2;

FIG. 9 is a front view in Embodiment 3;

FIG. 10 is a schematic exploded view in Embodiment 3;

FIG. 11 is a cross-sectional view in Embodiment 3;

FIG. 12 is a perspective view in Embodiment 4;

FIG. 13 is a schematic exploded view in Embodiment 4;

FIG. 14 is a cross-sectional view in Embodiment 4;

FIG. 15 is a schematic view showing the temperature inside and outside a lens in the prior art; and

FIG. 16 is a schematic view showing the temperature inside and outside a lens according to the present invention.

In the drawings: 10. optical lens; 20. layered thermal insulation assembly; 21. layered thermal insulation disk; 211. mounting step; 22. thermal insulation glass; 23. glass spacer gasket; 24. lens mounting member; 25. thermal insulation assembly supporting rod; 30. lens cover; and 40. lens waterproof ring.

### DETAILED DESCRIPTION

The present invention will be further described below with reference to accompanying drawings and specific embodiments. It should be noted that on the premise that there is no conflict, the embodiments or the technical features described below can be arbitrarily combined to form new embodiments.

In the description of the present invention, it needs to be understood that the terms “center”, “length”, “width”, “thickness”, “upper”, “lower”, “front”, “back”, “left”, “right”, “vertical”, “horizontal”, “top”, “bottom”, “inner”, “outer”, and the like indicate an orientation or positional relationship based on the orientation or positional relationship shown in the drawings, merely for ease of description of the present invention and simplification of the description, and are not intended to indicate or imply that the device or element referred to must have a particular orientation, and be constructed and operated in a particular orientation, and therefore should not be construed as limiting the present invention.

In addition, the terms “first” and “second” are used for descriptive purposes only and cannot be understood as indicating or implying relative importance or implicitly specifying the number of technical features indicated. Thus, the features defined with “first” and “second” may explicitly or implicitly include one or more of the features. In the description of the present invention, “a plurality of” means two or more, unless expressly and specifically defined otherwise.

In the description of the present invention, it should be noted that unless expressly specified and limited otherwise, the terms “mounted”, “connected”, and “connection” should be understood broadly, for example, it may be fixedly connected, detachably connected, or integrally connected; it may be mechanically connected or electrically connected; it may be directly connected or indirectly connected through an intermediate medium, and it may be internal communication of two components or an interaction relationship between two components. The specific meaning of the above terms in the present invention can be understood by those of ordinary skill in the art according to the specific situation.

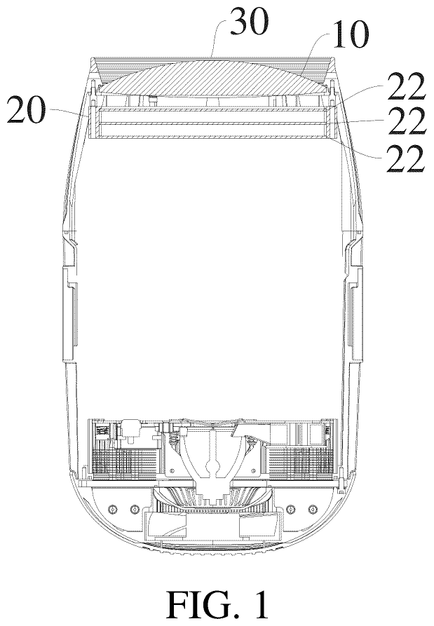

Referring to FIG. 1, the present invention discloses a lens oil and mist prevention device, mainly applied to a stage luminaire, and the lens oil and mist prevention device includes: an optical lens 10 and a layered thermal insulation assembly 20 disposed under the optical lens 10 (on the basis that a light emerging direction of the lamp faces upward). The optical lens 10 can be a light-emerging lens at a light-emerging side of the stage luminaire and can also be other lenses inside the stage luminaire, and in this embodiment, the light-emerging lens is taken as an example for explanation.

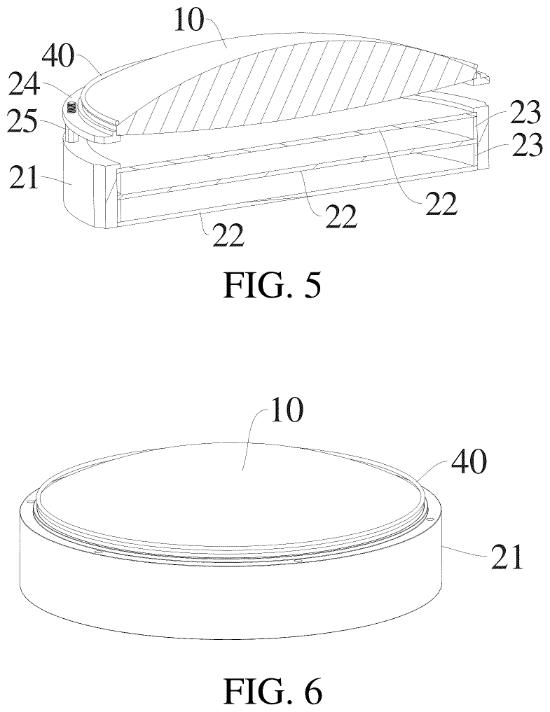

Referring to FIGS. 3 to 5, the layered thermal insulation assembly 20 includes a layered thermal insulation disk 21 playing a supporting role and one or more pieces of thermal insulation glass 22. The number of the thermal insulation glass 22 is set as needed, depending on the emission temperature of a light source and the target light-emerging temperature of the lamp, and one, two or more pieces of the thermal insulation glass 22 may be provided. The thermal insulation glass 22 is fixed in the layered thermal insulation disk 21 in a layered interval arrangement in the light emerging direction such that a plurality of stages of thermally insulating temperature division zones are formed in the layered thermal insulation disk 21. One thermally insulating temperature division zone is a chamber, the thermally insulating temperature division zones may be chambers independent from each other, i.e., different chambers do not communicate with each other; or different thermally insulating temperature division zones may be chambers communicating with each other.

The optical lens 10 is fixedly connected to the layered thermal insulation disk 21, or the optical lens 10 is directly sealed and fixed in the layered thermal insulation disk 21, and there is also a spacing between the optical lens 10 and the uppermost piece of the thermal insulation glass 22.

Specifically, when the number of the thermal insulation glass 22 is one, the thermally insulating temperature division zone will be formed between the thermal insulation glass 22 and the optical lens 10; and when the number of the thermal insulation glass 22 is two or more, in addition to forming the thermally insulating temperature division zone between the thermal insulation glass 22 and the optical lens 10, the thermally insulating temperature division zones are also formed between different thermal insulation glass 22.

Referring to FIG. 1, the optical lens 10 is located in a direction of a front end of the thermal insulation glass 22 so that a light beam of a light source of the lamp passes through the optical lens 10 and achieves light output after passing through the plurality of stages of the thermally insulating temperature division zones in sequence and being subjected to gradual cooling.

Based on different structures of the layered thermal insulation assembly 20 and different manners of connecting the optical lens 10 to the layered thermal insulation disk 21, the present invention can have the following four embodiments.

### Embodiment 1

Referring to FIGS. 3 to 5, the layered thermal insulation disk 21 has a hollow cylindrical structure. When the number of the thermal insulation glass 22 is at least two, the layered thermal insulation assembly 20 further includes glass spacer gaskets 23 for separating two pieces of the thermal insulation glass 22; and the glass spacer gaskets 23 are fixed in the layered thermal insulation disk 21, and the top and bottom of each glass spacer gasket 23 respectively abut against the thermal insulation glass 22, so that the thermally insulating temperature division zones are formed between different thermal insulation glass 22. The optical lens 10 and the layered thermal insulation assembly 20 are connected by using a lens mounting member 24 and thermal insulation assembly supporting rods 25, and one ends of a plurality of the thermal insulation assembly supporting rods are connected to the lens mounting member 24, and the other ends of the plurality of the thermal insulation assembly supporting rods are fixed to the layered thermal insulation disk 21, so that a gap is formed between the optical lens 10 and the uppermost piece of the thermal insulation glass 22; and this connection manner is more convenient for the installation or replacement of the optical lens 10.

### Embodiment 2

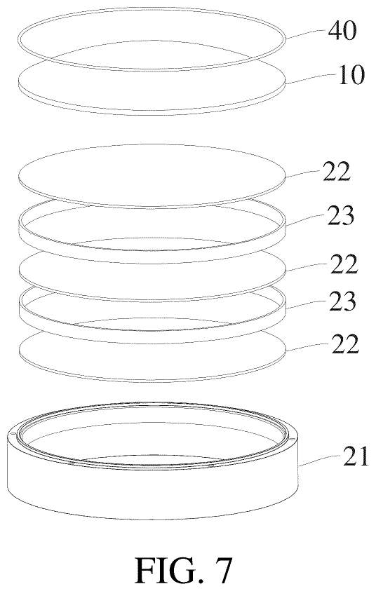

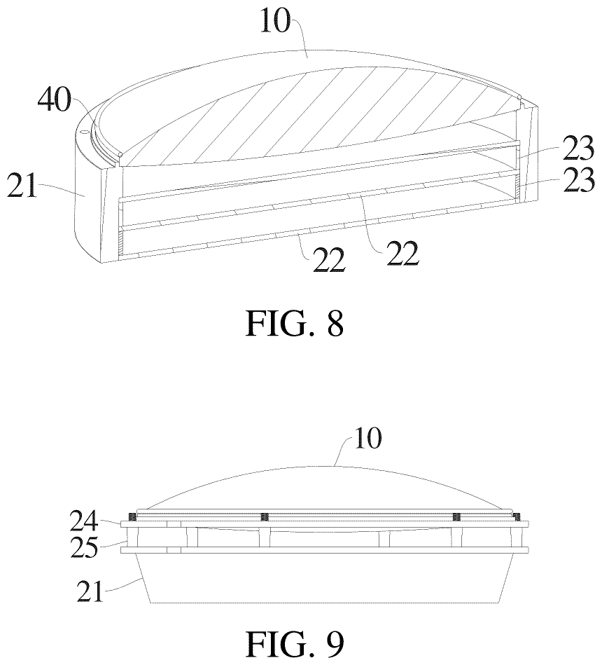

Referring to FIGS. 6 to 8, the structure of the layered thermal insulation disk 21 is the same as that in Embodiment 1, except that the optical lens 10 and the layered thermal insulation disk 21 are in the form of a full-sealed assembly. Specifically, the layered thermal insulation disk 21 has a hollow cylindrical structure. When the number of the thermal insulation glass 22 is at least two, the layered thermal insulation assembly 20 further includes glass spacer gaskets 23 for separating two pieces of the thermal insulation glass 22; the glass spacer gaskets 23 are fixed in the layered thermal insulation disk 21, and the top and bottom of each glass spacer gasket 23 respectively abut against the thermal insulation glass 22, so that the thermally insulating temperature division zones are formed between different thermal insulation glass 22. The optical lens 10 and the layered thermal insulation disk 21 are in the form of the full-sealed assembly: the top of the layered thermal insulation disk 21 is provided with a circle of mounting steps 211 for placing the optical lens 10; the optical lens 10 is fixedly disposed on the mounting steps 211, so that the bottom of the optical lens 10 is embedded inside the layered thermal insulation disk 21, and the optical lens 10 and the layered thermal insulation assembly 20 constitute a full-sealed member; and this connection manner is more conducive to the waterproof sealing properties of the assembly as a whole.

### Embodiment 3

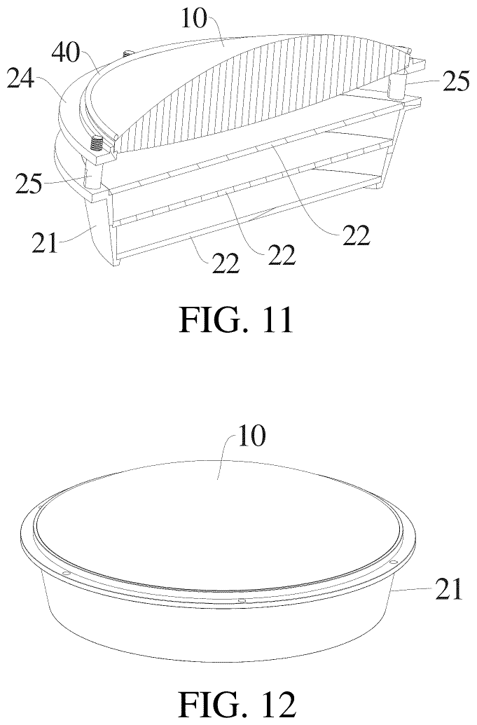

Referring to FIGS. 9 to 11, the structure of the layered thermal insulation disk 21 is different from that in Embodiment 1 and Embodiment 2. The layered thermal insulation disk 21 has a trumpet-like structure with a wide upper part and a narrow lower part; an inner side wall of the layered thermal insulation disk 21 is provided with a plurality of layers of mounting steps 211 for placing the thermal insulation glass 22; when the number of the thermal insulation glass 22 is at least two, the thermal insulation glass 22 is separately disposed on different mounting steps 211 so that the thermally insulating temperature division zones are formed between different thermal insulation glass 22; and this trumpet-like structure forms a matting slope to prevent a beam from reflecting out of a light outlet or blocking a light path. The optical lens 10 and the layered thermal insulation assembly 20 are connected by using a lens mounting member 24 and thermal insulation assembly supporting rods 25, and one ends of a plurality of the thermal insulation assembly supporting rods are connected to the lens mounting member 24, and the other ends of the plurality of the thermal insulation assembly supporting rods are fixed to the layered thermal insulation disk 21, so that a gap is formed between the optical lens 10 and the uppermost piece of the thermal insulation glass 22; and this connection manner is more convenient for the installation or replacement of the optical lens 10.

### Embodiment 4

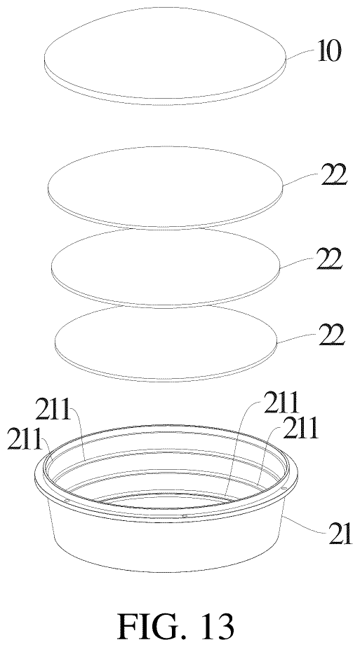

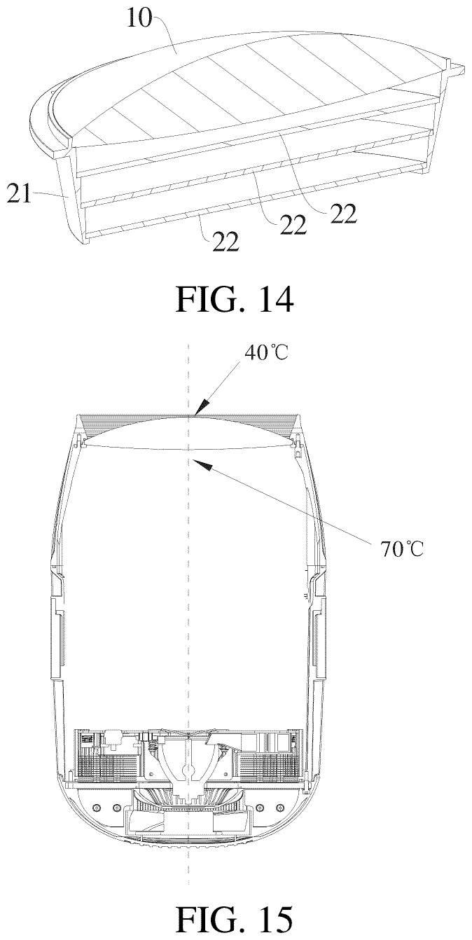

Referring to FIGS. 12 to 14, the structure of the layered thermal insulation disk 21 is the same as that in Embodiment 3. Specifically, the layered thermal insulation disk 21 has a trumpet-like structure. When the number of the thermal insulation glass 22 is at least two, the layered thermal insulation assembly 20 further includes glass spacer gaskets 23 for separating two pieces of the thermal insulation glass 22; the glass spacer gaskets 23 are fixed in the layered thermal insulation disk 21, and the top and bottom of each glass spacer gasket 23 respectively abut against the thermal insulation glass 22, so that the thermally insulating temperature division zones are formed between different thermal insulation glass 22; and this trumpet-like structure forms a matting slope to prevent a beam from reflecting out of a light outlet or blocking a light path. The difference from Embodiment 3 is that the optical lens 10 and the layered thermal insulation disk 21 are in the form of a full-sealed assembly: the top of the layered thermal insulation disk 21 is provided with a circle of mounting steps 211 for placing the optical lens 10; the optical lens 10 is fixedly disposed on the mounting steps 211, so that the bottom of the optical lens 10 is embedded inside the layered thermal insulation disk 21, and the optical lens 10 and the layered thermal insulation assembly 20 constitute a full-sealed member; and this connection manner is more conducive to the waterproof sealing properties of the assembly as a whole.

Compared with the prior art, the present invention can achieve the following beneficial effects:
the layered thermal insulation assembly 20 is disposed at a front end, close to the optical lens 10, of the optical path, and by arranging one, two or more pieces of thermal insulation glass 22 in the layered thermal insulation disk 21 as needed, one, two or more stages of the thermally insulating temperature division zones are formed. When the light beam of the light source passes through the thermally insulating temperature division zones in sequence, the effect of gradual cooling is achieved, so that inner and outer sides of each piece of the layered thermal insulation glass 22 or the optical lens 10 are close to heat balance, i.e., a temperature difference between the inner and outer sides is reduced, and condensation of oil mist and water vapor is effectively avoided, and a good oil and mist prevention effect is achieved in practical use.

Compared with the prior art in which the accumulated oil stain and water mist are discharged by means of internal or external circulation of the air flow inside the lamp, in the present invention, the natural generation and accumulation of oil stain and water mist in the lamp are basically eliminated from the source by means of a way that heat balance is achieved inside and outside the lens and the temperature difference is reduced, while designing a multi-layer thermal insulation zone as needed to gradually lower the temperature, and the oil and mist prevention effect is significantly better. Moreover, it is not necessary to discharge gas in the lamp frequently and regularly, saving maintenance costs of a stage luminaire; and it is also not necessary to dispose various air blowing devices, air guiding devices, airflow circuits and the like inside the lamp, saving the cost of lamp accessories, and the internal structure of the stage luminaire can be more compact, lightweight and miniaturized, which is more in line with the current development trend of the stage luminaire.

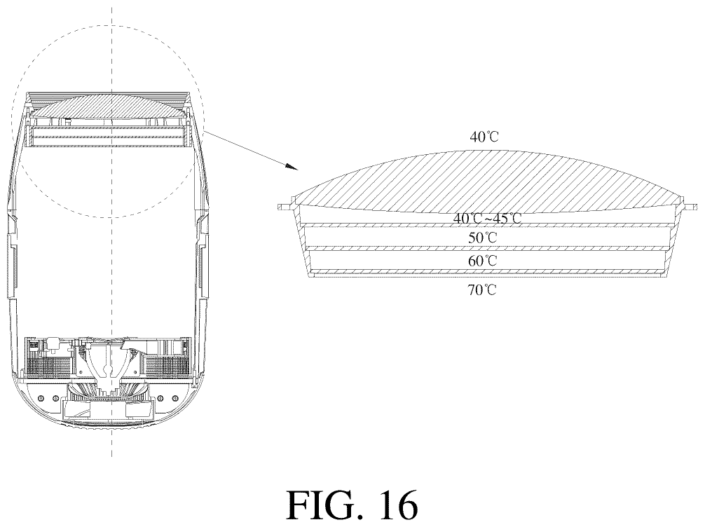

As evidence, in an actual test under a specific operating condition, referring to FIG. 15, in the prior art in which the layered thermal insulation assembly in the present invention is not applied, the temperature inside the lamp is about 70° C., the temperature outside the optical lens 10 is about 40° C., and a temperature difference between the inside and outside of the optical lens 10 is about 30° C., which is very likely to cause generation and condensation of the oil mist and water vapor. As a comparison, referring to FIG. 16, in this technical solution in which the layered thermal insulation assembly is applied, taking the condition that three layers of thermal insulation glass (three thermally insulating temperature division zones) are applied as an example, the temperature inside the lamp is about 70° C., and the temperatures of the thermally insulating temperature division zones from bottom to top are about 60° C., 50° C., and 40° C. in sequence, wherein the theoretical error value of the thermally insulating temperature division zone in the uppermost layer is not more than 5° C., while the temperature outside the optical lens 10 is about 40° C., that is, a temperature difference between the inside and outside of the optical lens 10 is close to 0° C. while not exceeding 5° C. at maximum. Under this condition, oil stain and water mist caused by the temperature difference can basically be eliminated.

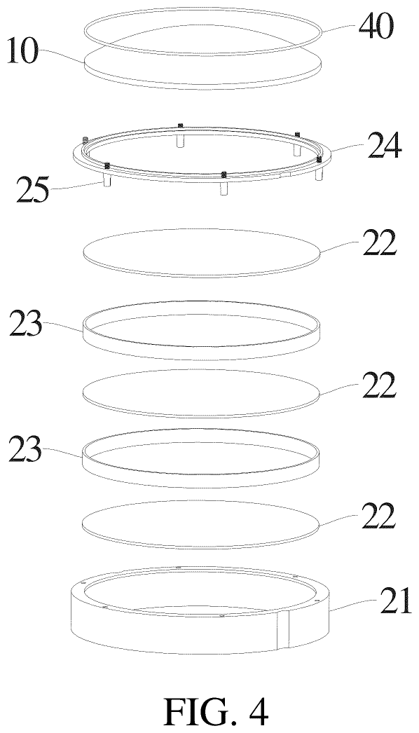

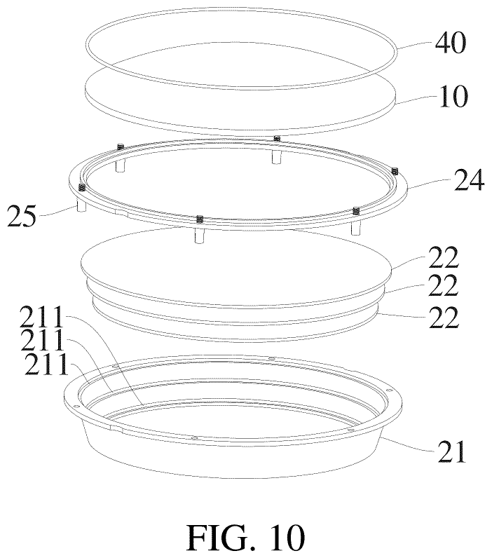

In Embodiments 1 and 3, in order to improve the waterproof sealing performance of the assembly, referring to FIGS. 4 and 10, the optical lens 10 is further covered with a lens waterproof ring 40.

Preferably, the thermal insulation glass 22 can adopt temperature-resistant and high-permeability coated optical glass, oil mist-resistant coated glass, temperature-resistant heat insulation glass 22, or other ordinary glass.

Preferably, the surfaces of the layered thermal insulation disk 21 and the glass spacer gasket 23 are provided with black matting patterns or subjected to anti-reflective treatment to make the light emerging effect of the light beam more concentrated.

Preferably, in order to achieve a better cooling effect, an interval gap inside the layered thermal insulation assembly 20 can be filled with inert gas or vacuumized; and of course, it is also possible to use only natural air for filling.

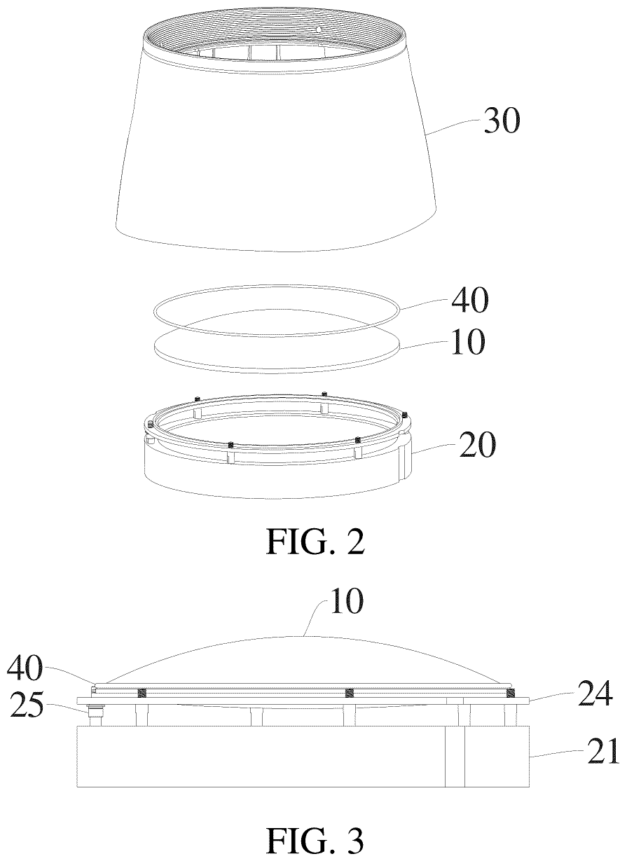

Preferably, with reference to FIGS. 1 and 2, the lens oil and mist prevention device of the present invention further includes a lens cover 30 that serves to support the optical lens 10 and the layered thermal insulation assembly 20 and provide mounting locations for the optical lens 10 and the layered thermal insulation assembly 20, and the optical lens 10 and the layered thermal insulation assembly 20 are both fixed in the lens cover 30.

The present invention also discloses a stage luminaire, including the above lens oil and mist prevention device, and of course also other functional components commonly used in the stage luminaire, such as a light source heat dissipation component, a zooming component and the like. The stage luminaire employing the same or substantially the same lens oil and mist prevention device should be within the scope of protection of the present invention.

The above embodiments are only preferred embodiments of the present invention and are not intended to be construed as limiting the scope of protection of the present invention, and any insubstantial changes and substitutions may be made by those skilled in the art on the basis of the present invention fall within the scope of protection of the present invention.

What is claimed is:

1. A lens oil and mist prevention device, characterized by comprising:
an optical lens; and
a layered thermal insulation assembly disposed under the optical lens, comprising: a layered thermal insulation disk and one or more pieces of thermal insulation glass, wherein the thermal insulation glass is fixed in the layered thermal insulation disk in a layered interval arrangement in a light emerging direction such that a plurality of stages of thermally insulating temperature division zones are formed in the layered thermal insulation disk; and the thermally insulating temperature division zones are chambers independent from each other, or different thermally insulating temperature division zones are chambers communicating with each other; and
the optical lens is fixedly connected to the layered thermal insulation disk, or the optical lens is sealed and fixed in the layered thermal insulation disk; and the optical lens is disposed in a direction of a front end of the thermal insulation glass such that a lamp beam reaches the optical lens after sequentially passing through the plurality of stages of the thermally insulating temperature division zones.

2. The lens oil and mist prevention device according to claim 1, characterized in that the layered thermal insulation disk has a hollow cylindrical structure; when the number of the thermal insulation glass is at least two, the layered thermal insulation assembly further comprises: a glass spacer gasket; and the glass spacer gasket is fixed in the layered thermal insulation disk, and a top and a bottom of the glass spacer gasket respectively abut against the thermal insulation glass to form the thermally insulating temperature division zones between different thermal insulation glass.

3. The lens oil and mist prevention device according to claim 1, characterized in that the layered thermal insulation disk has a trumpet-like structure with a wide upper part and a narrow lower part; an inner side wall of the layered thermal insulation disk is provided with a plurality of layers of mounting steps for placing the thermal insulation glass; and when the number of the thermal insulation glass is at least two, the thermal insulation glass is separately disposed on different mounting steps to form the thermally insulating temperature division zones between different thermal insulation glass.

4. The lens oil and mist prevention device according to claim 1, characterized in that when the optical lens is fixedly connected to the layered thermal insulation disk, the lens oil and mist prevention device further comprises: a lens mounting member and thermal insulation assembly supporting rods; and the optical lens is fixed in the lens mounting member, one ends of a plurality of the thermal insulation assembly supporting rods are connected to the lens mounting member, and the other ends of the plurality of the thermal insulation assembly supporting rods are fixed to the layered thermal insulation disk.

5. The lens oil and mist prevention device according to claim 1, characterized in that when the optical lens is sealed and fixed in the layered thermal insulation disk, a top of the layered thermal insulation disk is provided with a circle of mounting steps for placing the optical lens; and the optical lens is fixedly disposed on the mounting steps so that a bottom of the optical lens is embedded inside the layered thermal insulation disk.

6. The lens oil and mist prevention device according to claim 1, characterized in that the thermal insulation glass is any one of temperature-resistant and high-permeability coated optical glass, oil mist-resistant coated glass, temperature-resistant heat insulation glass, and ordinary glass.

7. The lens oil and mist prevention device according to claim 2, characterized in that surfaces of the layered thermal insulation disk and the glass spacer gasket are provided with black matting patterns or an anti-reflection treatment layer.

8. The lens oil and mist prevention device according to claim 1, characterized in that an interval gap inside the layered thermal insulation assembly is any one of an inert gas filling layer, a vacuum layer, and a natural air filling layer.

9. The lens oil and mist prevention device according to claim 1, characterized by further comprising: a lens cover, wherein the optical lens and the layered thermal insulation assembly are both fixed in the lens cover.

10. A stage luminaire, characterized by comprising the lens oil and mist prevention device according to claim 1.

11. A stage luminaire, characterized by comprising the lens oil and mist prevention device according to claim 2.

12. A stage luminaire, characterized by comprising the lens oil and mist prevention device according to claim 3.

13. A stage luminaire, characterized by comprising the lens oil and mist prevention device according to claim 4.

14. A stage luminaire, characterized by comprising the lens oil and mist prevention device according to claim 5.

15. A stage luminaire, characterized by comprising the lens oil and mist prevention device according to claim 6.

16. A stage luminaire, characterized by comprising the lens oil and mist prevention device according to claim 7.

17. A stage luminaire, characterized by comprising the lens oil and mist prevention device according to claim 8.

18. A stage luminaire, characterized by comprising the lens oil and mist prevention device according to claim 9.
